(19) United States
(12) Patent Application Publication
(10) Pub. No.: US 2022/0223358 A1
(43) Pub. Date: Jul. 14, 2022

(54) CONTROL ELEMENT

(71) Applicant: ZF Friedrichshafen AG, Friedrichshafen (DE)

(72) Inventors: Erwin Biegger, Wangen im Allgäu (DE); Fabian Schrader, Friedrichshafen (DE); Georg Tenckhoff, Altshausen (DE); Michael Pantke, Friedrichshafen (DE); Joachim Biller, Lorch (DE)

(73) Assignee: ZF Friedrichshafen AG, Friedrichshafen (DE)

(21) Appl. No.: 17/607,692

(22) PCT Filed: Mar. 4, 2020
(86) PCT No.: PCT/EP2020/055716

§ 371 Date: Oct. 29, 2021

(30) Foreign Application Priority Data
Apr. 30, 2019 (DE) 10 2019 206 229.6

(51) Int. Cl. H01H 13/20; G05G 1/02; G05G 5/03; G05G 1/10; H01H 13/14

(52) U.S. Cl. CPC H01H 13/20; G05G 1/02; H01H 13/14; G05G 1/10; G05G 5/03

(57) ABSTRACT

A control element comprises an electro-rheological material and at least one driver assembly for generating a variable magnetic field. A variable feel that can be registered by a user can be generated by means of the driver assembly.

The invention relates to a control element used in a vehicle, in particular a motor vehicle, rail vehicle, aircraft or boat.

There are numerous control elements in vehicles that can easily distract an operator of the vehicle. These distractions can result in undesired reactions, or cause an accident.

Based on this, the fundamental object of the invention is to create a control element that distracts the user as little as possible.

This object is achieved by a control element comprising an electro-rheological material, which has at least one driver assembly for generating a variable electric field.

The object is achieved entirely in this manner.

According to the invention, a change in the feel of the control element can be generated by a change in the electric field. This can be obtained in particular through a change in the shape and/or texture of the control element. It is possible to communicate with the user of the control element in this manner, without the user having to actually look at the control element, thus forming a distraction.

According to another embodiment of the invention, the electro-rheological material contains an electro-rheological elastomer.

According to another embodiment of the invention, the electro-rheological material contains an electro-rheological liquid.

In both cases, the electro-rheological properties of the material can be used to change the properties of the electro-rheological material through the application an electric field.

If the elastomer is electro-rheological, it is an elastomer that can be polarized electrically. Some elastomers that can be polarized electrically, e.g. polyvinyl chloride, PVC. Other elastomers are difficult to polarize, e.g. styrol-rubber materials, e.g. SEBS, SIBS, SEPS. Polarizable particles can also be dispersed in the elastomer.

If an electro-rheological liquid is used, it is clear that it must be sealed in a suitable hollow chamber.

While electro-rheological elastomers can change shape and rigidity under the effects of an electric field, this effect is limited to a change in viscosity with electro-rheological liquids.

In both cases, there is a noticeable change in the feel for a user.

In the simplest case, driver assembly comprises a first and second electrode, between which an electric field can be applied.

This driver assembly preferably contains at least one flexible electrode, and the electro-rheological material is at least partially located between the electrodes.

Because at least one of the electrodes is therefore located at the end of the element formed by the electro-rheological material, and the shape of the element, in particular its length or width, can change, the electrode in question is preferably flexible.

According to a preferred embodiment of the invention, the driver assembly is designed to generate a vibration in the control element, in particular with different frequencies, different durations, and/or with an intermittent output, that the user can distinguish.

This makes it possible to indicate to a user through a vibration that an input, for example, has taken place correctly.

It is therefore possible, for example, to indicate to a user through a vibration that an input has taken place correctly, i.e. a telephone number has been fully input. Or it is possible to indicate to a user through different frequencies whether an input should take place to increase a specific value or decrease this value. Moreover, different frequencies can be used to give a user certain feedback, or request a specific input. Different durations and/or an intermittent output of a frequency can be used in a corresponding manner to communicate with a user.

According to another embodiment of the invention, the driver assembly is designed to allow at least part of the control element to protrude from or recess into a surface when activated.

The control element can then remain recessed in a surface when it is not needed, for example, and only protrude when input is needed.

The control element is preferably a knob or button.

According to another embodiment of the invention, the control element comprises numerous individual control elements, each of which has its own driver assembly.

An entire input panel can be obtained in this manner, e.g. for inputting a telephone number.

According to another embodiment of the invention, the first electrode is configured to actuate an electric switch mechanism, and can be moved manually, at least in part.

While the control element can otherwise be part of an electric switch mechanism, e.g. in the form of a rod or knob for actuating a switch, the control element can also be part of an electric switch mechanism that is actuated directly via the first electrode. The first electrode can preferably have a flexible segment, via which it is actuated.

In another embodiment of the invention, the first electrode is located on a first end of an electro-rheological elastomer, and comes in contact with an intermediate electrode when it is activated manually.

The electric switch mechanism can therefore be obtained between the first electrode and the intermediate electrode. The driver assembly is coupled to the first electrode and the second electrode, which is located on the other end of the elastomer. The change in feel is caused by the driver assembly.

This results in a particularly simple and compact design for the control element, resulting in both a switch mechanism, and a variable feel, with which it is possible to communicate with the user.

In another embodiment of the invention, there is a first electrode at one end and a second electrode at the other end of the elastomer. Both electrodes are coupled to the driver assembly, in order to obtain the variable feel. This switch mechanism has means for monitoring a change in the capacitance between the first and second electrodes, in order to register a movement of the first electrode. This enables a switching of the electric switch mechanism.

The control element can be combined in this manner with an electric switch mechanism, and galvanically separated from the driver assembly.

A control element according to the invention can preferably be produced through 3D printing.

Nearly any shape can be produced with 3D printing, such that the control element can be readily adapted to different applications and requirements.

As mentioned above, a control element according to the invention can preferably be used to communicate with a user, in that a noticeable change in the feel of the control element is produced. By way of example, a vibration can be used to give a user feedback regarding an activation of the control element, or request input from the user.

As mentioned above, a control element according to the invention can preferably be used in a vehicle, in particular a motor vehicle, rail vehicle, aircraft, or boat.

It is clear that the features of the invention specified above and explained below can be used not only in the respective combinations specified herein, but also in other combinations or in and of themselves, without abandoning the framework of the invention.

Further features and advantages of the invention can be derived from the following description of preferred exemplary embodiments in reference to the drawings. Therein:

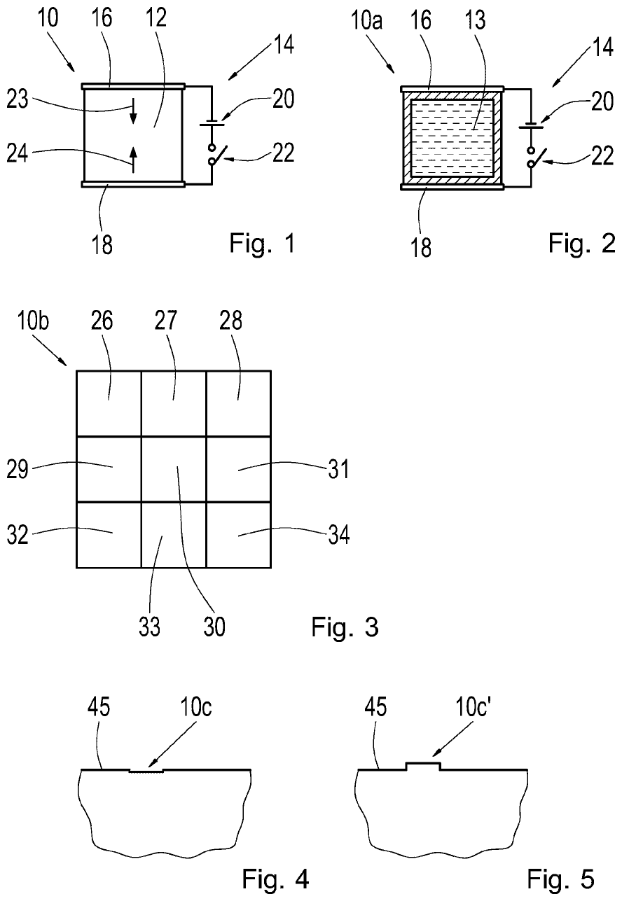

FIG. 1 shows a schematic illustration of a control element according to the invention with an electro-rheological elastomer;

FIG. 2 shows a schematic illustration of a control element according to the invention with an electro-rheological liquid;

FIG. 3 shows a schematic illustration of a control element according to the invention composed of numerous individual electro-rheological elements;

FIG. 4 shows a partial view of a control element according to the invention, recessed in a surface when not in the activated state;

FIG. 5 shows a view of the control element shown in FIG. 5, in the activated state, wherein it protrudes partially from the surface;

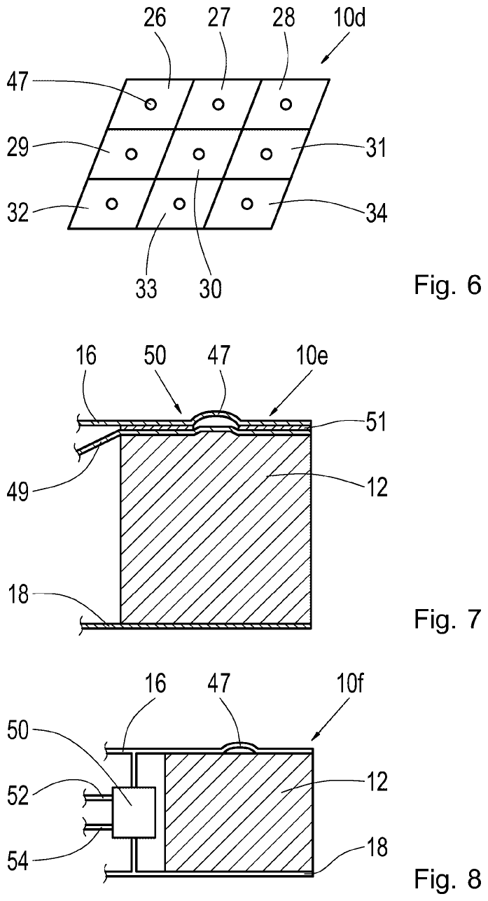

FIG. 6 shows a schematic illustration of a control element composed of nine individual elements, wherein each individual element also has a switching surface;

FIG. 7 shows an enlargement of another embodiment of a control element according to the invention, which can be used as an electric switching element and also contains an electro-rheological elastomer for communicating with a user by changing the feel; and

FIG. 8 shows an enlargement of another embodiment of a control element according to the invention, which can be used as an electric switching element and also contains an electro-rheological elastomer for communicating with a user by changing the feel, wherein the electric switching element electronically evaluates the change in capacitance in order to trigger a switching process.

A control element according to the invention is indicated on the whole with the numeral 10 in the schematic illustration in FIG. 1. This is a control element 10 with an electro-rheological elastomer 12 in the form of a block, with an electric electrode on each end, a first electrode 16 and a second electrode 18. A driver assembly 14 can provide electrical power to the two electrodes 16, 18. A power source 20 is provided for this, shown schematically herein, as well as a switch. The power source 20 is normally an electronic power source that outputs a DC voltage or AC voltage, and the switch 22 is normally an electronic switch, operated via a suitable control.

Polarizable particles are dispersed in the electro-rheological elastomer 12, that can be reversed when an electric field is applied. This results in a contraction, as indicated by the two arrows 23, 24 in FIG. 1. The elastomer itself can also be polarizable.

Because the electrodes 16, 18 are located on the ends of the elastomer 12, they should be flexible, such that they can participate in a change in shape. The length or cross section, and/or the rigidity of the elastomer 12 can be altered by the driver assembly 14, comprising the power source 20 and the switch 22. A vibration can also be generated.

It should be clear that the electro-rheological elastomer 12 can be not only block-shaped, but practically any shape that can be produced with 3D printing. It can therefore be hollow, or a structured hollow shape, with various identical or different individual elements.

FIG. 2 shows a second embodiment of the control element according to the invention in a schematic illustration, indicated on the whole with the numeral 10a. Corresponding reference symbols are used for corresponding parts herein, as is also the case in the following figures.

In the embodiment shown in FIG. 2, instead of an electro-rheological elastomer, an electro-rheological liquid 13 is used, which is sealed in a hollow chamber in an elastomer.

When an electric field is applied to the two electrodes 16, 18, the electro-rheological (polarizable) molecules in the liquid become aligned between the electrodes 16, 18, resulting in a greater rigidity in the system.

The control element 10 or 10a shown in FIGS. 1 and 2 can be part of a switching element with which an electric switch is actuated. The control element 10 or 10a can therefore be part of a mechanical rod with which an electric switch is actuated. The driver assembly 14 is used to generate a variable feel by changing the shape and/or rigidity of the elastomer 12, or liquid 13 that a user can notice.

As a result, feedback can be given to a user regarding whether the control element can been correctly actuated, to actuate a specific input. Furthermore, the elastomer 12 can be caused to vibrate, wherein different frequencies, durations, and/or an intermittent output can be used for exchanging information with the user.

The control element can also comprise numerous individual elements, as shown in FIG. 3.

The control element 10b shown in FIG. 3 is composed, by way of example, of nine individual control elements 26, 27, 28, 29, 30, 31, 32, 33, 34, arranged in the manner of a checkerboard. Each individual control element 26 to 34 contains its own driver assembly 14, and can be controlled individually (connections not shown).

This allows for the realization of larger input fields, e.g. such as those for a telephone keypad. An individual switching can be implemented with each individual control element 26 to 34, and communication with the user can take place through a change in shape or rigidity, thus generating a different feel that can be registered by a user.

Another embodiment of a control element according to the invention is shown in FIGS. 4 and 5, indicated on the whole by the numeral 10d. This control element 10d is recessed in a surface 45 and can move therein. When activated, a part of the control element 10d′ protrudes from the surface 45, as indicated by way of example in FIG. 5.

FIG. 6 shows another control element, indicated on the whole with the numeral 10d, which is comprised of nine individual control elements 26 to 34 in a checkerboard arrangement. Each individual control element 26 to 34 also has a switching surface 47 that triggers an electric switching process when activated manually. As a result of the structure, a certain pressure characteristic is obtained when it is not activated, through which a switching process can be triggered when actuated manually (fail-safe operation). In the activated state, the switching characteristic can be altered, and communication can be established with the user, as described above.

FIG. 7 shows another control element by way of example, indicated on the whole with the numeral 10e. This is a control element with which an electric switching element 50 is obtained with two electrodes 16, 49, and which is also combined with an electro-rheological elastomer 12 in order to generate a variable feel.

There is a first electrode 16 at a first end of the electro-rheological elastomer 12, which has a protruding switching surface 47. Adjacent to this is an intermediate electrode 49, which is electrically insulated from the first electrode 16 by an insulation layer 51. If the protruding switching surface is depressed, contact is made with the underlying intermediate electrode 49, such that an electric switching process takes place between the first electrode 16 and the intermediate electrode 49.

The second electrode is at the other end of the electro-rheological elastomer 12. An electric field can be applied between the first electrode 16 and second electrode 18 by a driver assembly in the manner described above, in order to change the shape or length or generate a variable feel.

Lastly, FIG. 8 shows a variation on the embodiment shown in FIG. 7. The control element 10f also has a first electrode 16 and second electrode 18, with an electro-rheological elastomer 12 sealed between them. The first electrode 16 also has a protruding switching surface 47 that can be actuated manually.

In differing from the embodiment shown in FIG. 7, there is no intermediate electrode. Instead, the capacitance between the two electrodes 16, 18 is monitored. When the switching surface 47 is depressed, the switch mechanism 50 registers a change in the capacitance, and executes a switching process between the two connections 52, 54. A galvanic separation can be obtained for this between the two connections 52, 54 and the two electrodes 16, 18.

### REFERENCE SYMBOLS

10, 10a, 10b, 10c, 10d, 10e, 10f control element

12 elastomer

13 liquid

14 driver assembly

15 coil

16 first electrode

18 second electrode

20 power source

22 switch

23 arrow

24 arrow

26 individual control element

27 individual control element

28 individual control element

29 individual control element

30 individual control element

31 individual control element

32 individual control element

33 individual control element

34 individual control element

35 individual driver assembly

36 individual driver assembly

37 individual driver assembly

38 individual driver assembly

39 individual driver assembly

40 individual driver assembly

41 individual driver assembly

42 individual driver assembly

43 individual driver assembly

45 surface

47 switching surface

49 intermediate electrode

50 switching element

52 connection

54 connection

1. A control element comprising an electro-rheological material and at least one driver assembly configured to generate a variable electric field.

2. The control element according to claim 1, wherein the electro-rheological material contains an electro-rheological elastomer.

3. The control element according to claim 1, wherein the electro-rheological material comprises an electro-rheological liquid.

4. The control element according to claim 1, wherein the driver assembly comprises a first electrode and second electrode, between which the variable electric field can be applied.

5. The control element according to claim 4, wherein the driver assembly has at least one flexible electrode, and the electro-rheological material is located at least in part between the electrodes.

6. The control element according to claim 1, configured to generate a noticeable variable feel for the user.

7. The control element according to claim 1, wherein the driver assembly is configured to vary the rigidity of the control element.

8. The control element according to claim 1, wherein the driver assembly is configured to vary the shape of the control element.

9. The control element according to claim 1, wherein the driver assembly is configured to generate a vibration in the control element at least one of with different frequencies, with different durations, or with an intermittent output, that can be registered by the user.

10. The control element according to claim 1, wherein the driver assembly is configured to allow at least part of the control element to at least one of protrude from a surface or recess into a surface when activated.

11. The control element according to claim 1 comprising a knob or button.

12. The control element according to claim 1, comprising numerous individual control elements each of which has an individual driver assembly.

13. The control element according to claim 5, wherein the first electrode is configured to be moved manually, at least in part, to actuate an electric switch mechanism.

14. The control element according to claim 13, further comprising a first electrode on a first end, configured to come in contact with an intermediate electrode when manually activated to obtain the electric switch mechanism, and a second electrode on the other end of the elastomer, and is coupled to the first electrode in order to obtain the variable feel.

15. The control element according to claim 13, further comprising a first electrode on a first end, and a second electrode on the other end of the elastomer, and which is coupled along with the first electrode to the driver assembly to obtain the variable feel, wherein the electric switch mechanism is configured to monitor a change in the capacitance between the first and second electrodes to obtain an electric circuit.

16. The control element according to claim 1, wherein the control element is produced with 3D printing.

17. A method comprising: Use of the control element according to an of the preceding claims, wherein the control element communicating with a user using a control element according to claim 1 by providing a change in a feel of the control element for the user, wherein the communicating comprises at least one of providing feedback regarding an activation of the control element or requesting an input from a user, through a vibration.

18. A vehicle comprising of the control element according to claim 1.
